(19) United States
(12) Patent Application Publication
(10) Pub. No.: US 2004/0081227 A1
(43) Pub. Date: Apr. 29, 2004

(54) System and method for spreading/despreading in multi-carrier code division multiple access

(76) Inventors: Kwang-Jae Lim, Daejeon (KR); Soo-Young Kim, Daejeon (KR); Deock-Gil Oh, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/406,973

(22) Filed: Apr. 3, 2003

(30) Foreign Application Priority Data
Oct. 25, 2002 (KR) 2002-65490

(51) Int. Cl. H04B 1/707; H04B 1/69

(52) U.S. Cl. 375/140

(57) ABSTRACT

A system and a method for spreading/despreading in MC-CDMA are disclosed. Simple spreading and despreading procedures are provided to allow both frequency and time spreading/despreading. The system and method for spreading/despreading in MC-CDMA produce a high processing gain, frequency diversity, and multipath time diversity through two-dimensional time/frequency spreading/despreading. Moreover, the spreading/despreading system and method support a variable transmission rate by simply changing the spreading factor without changing the spreading/despreading procedure and structure.

### BACKGROUND OF THE INVENTION

1. Field of the Invention

The present invention is related to a system and method for spreading/despreading in multi-carrier code division multiple access (MC-CDMA), and more particularly, to a system and method for spreading/despreading in MC-CDMA for easily carrying out two-dimensional time/frequency spreading/despreading of direct spreading in time domain and frequency spreading over multiple subcarriers, and easily supporting a variable spreading factor.

2. Background of the Related Art

FIG. 1 illustrates the configuration of a transmitter of a conventional MC-CDMA system. Referring to FIG. 1, the transmitter of the conventional MC-CDMA includes a serial/parallel converter 11, a modulation symbol mapping unit 12, a symbol copying unit 13, a multiplier 14, an inverse Fourier transform unit 15, and a guard time insertion unit 16.

The serial/parallel converter 11 divides a bit sequence to be transmitted into J parallel bit streams through serial-to-parallel conversion or demultiplexing. The modulation symbol mapping unit 12 converts each of the bit streams divided by the serial/parallel converter 11 into a complex symbol sequence according to a modulation method such as M-ary PSK or M-ary QAM.

The symbol copying unit 13 copies each modulated symbol to produce as many parallel symbol sequences as there are subcarriers with which the symbols are to be spread and transmitted, i.e. the spreading factor (SF_{F}). Then, the multiplier 14 multiplies each of the copied symbols by a code chip Cₙ assigned to the corresponding subcarrier. Here, a Walsh code can be used as the spreading code (C=<C₀, C₁, . . . , C_{SF}_{_{F}}₋₁>) for orthogonality among signals simultaneously transmitted.

In general, Walsh codes are used together with pseudo-noise scrambling, in order to discriminate among different signal sources such as base stations or mobile stations.

The inverse Fourier transform unit 15 transforms the J×SF_{F} spread chips into a sample sequence transmitted over J×SF_{F} subcarriers. Here, the inverse Fourier transform unit 15 uses Inverse Discrete Fourier Transform (IDFT) for frequency transform or Inverse Fast Fourier Transform (IFFT).

The number of subcarriers used for frequency transform of each symbol sequence corresponds to SF_{F}, which is the spreading factor. For all the J symbol sequences, the number of subcarriers is equal to J×SF_{F}. A transmission symbol generated by the inverse Fourier transform unit 15 includes J×SF_{F} samples.

The guard time insertion unit 16 adds a guard time to the head of each transmission symbol in order to avoid inter-symbol interference that is generated due to multi-path propagation in channels. Finally, the transmission symbol with guard time is converted into RF signal to be transmitted.

FIG. 2 illustrates the configuration of the spreading system corresponding to one modulation symbol sequence in FIG. 1, and FIG. 3 illustrates the configuration of a spreading system of MC-CDMA having a spreading factor reduced P times.

As shown in FIG. 2, the spreading procedure is carried out in such a manner that the symbol copying unit 13 copies each modulated symbol S_{K} to produce as many parallel symbols as there are subcarriers, SF_{F}, over which the symbol is to be spread and transmitted, and the multiplier 14 multiplies each copied symbol by one code chip (Cₙ(n=0, 1, . . . , SF_{F}−1)) allocated to a corresponding subcarrier, among the spectrum spreading code C. The parallel chip sequences generated by the multiplier 14 are fed to the inverse Fourier transform unit 15 for multi-carrier transmission.

The CDMA system may employ a method of varying the spreading factor for each symbol in order to provide a variable transmission rate for appropriately controlling a data transmission rate according to a variation in the data generation rate or a variation in the channel state, as in the WCDMA technology of a third-generation mobile communication system.

In the case where the variable spreading factor is applied to the spreading procedure in the MC-CDMA system of FIG. 2, in order to spread and transmit the modulated symbols with a spreading factor SF_{F}/P for a P-time increased transmission rate, the spreading structure must be changed into one as shown in FIG. 3, which includes a serial/parallel converter 21, a symbol copying unit 22, a multiplier 23, and an inverse Fourier transform unit 24.

In such conventional method, there is a problem that the number of branches generated in parallel in the serial/parallel conversion procedure, that is, the number of branches corresponding to the outputs of the serial/parallel converter 21 or the inputs of the inverse Fourier transform unit 24, should be controlled according to P, and the connection between the components in the spreading system should be rearranged.

FIG. 4 shows a despreading system of a conventional MC-CDMA receiver. Referring to FIG. 4, the conventional despreading system includes a Fourier transform unit 31, a multiplier 32, a weighting unit 33, a combiner 34, and a parallel/serial converter 35.

The Fourier transform unit 31 performs a Fourier transform of a received sample sequence and divides it into SF_{F} parallel chip sequences corresponding to each subcarrier. The multiplier 32 and weighting unit 33 multiply each of the symbols by a code chip Cₙ corresponding to each subcarrier and an appropriate weight Wₙ, respectively. The combiner 34 combines as many chips as the spreading factor, SF_{F}/P, and the parallel/serial converter 35 converts the combined chips into one symbol.

A weight for each of the received chips is determined according to a chip combing method. The combining method includes ORC (Orthogonality Restoring Combining), EGC (Equal Gain Combining), MRC (Maximal Ratio Combining), MMSEC (Minimum Mean Square Error Combining), and the like. For example, the weighting unit 33 may simply perform the combining with the same weight for all received chips.

Similar to the spreading procedure of the transmitter shown in FIG. 3, the despreading procedure of the receiver shown in FIG. 4 also has a problem in that the number of chips to be combined should be changed and the connection of branches to the combiner 34 should be rearranged according to the varying spreading factor, SF_{F}/P.

In the case where both the frequency spreading/despreading and the direct time spreading/despreading are simultaneously required, the aforementioned conventional spreading/despreading methods should add direct spreading and despreading procedures for each branch and appropriately arrange a code corresponding to each branch for carrying out two-dimensional frequency/time spreading and despreading.

Furthermore, in the case where the variable spreading factor is applied to the two-dimensional frequency/time spreading and despreading, spreading and despreading structures should be rearranged depending on the varying spreading factor.

### SUMMARY OF THE INVENTION

Accordingly, the present invention is related to a system and a method for spreading/despreading in MC-CDMA that substantially solves one or more problems due to limitations and disadvantages of the related art.

An object of the present invention is to provide a system and a method for spreading/despreading in MC-CDMA for easily carrying out two-dimensional hybrid time/frequency spreading and despreading and easily providing a variable spreading factor.

To accomplish the object of the present invention, a spreading system in MC-CDMA is provided, which comprises a symbol repeating unit for repeating each symbol of a modulated symbol sequence for spreading, with the number of repetitions, R, which is determined by a variable spreading factor; a spreading unit for performing a direct spreading for the repeated symbols using a spreading code of the same chip rate as the repeated symbol rate, to obtain a spread chip sequence; a demultiplexer for dividing the spread chip sequence into as many parallel chip sequences as there are subcarriers, SF_{F}, as a serial/parallel conversion; and an inverse Fourier transform unit for transforming the chips into a transmission symbol, which is a sample sequence including SF_{F} samples, for multi-carrier transmission.

To accomplish the object of the present invention, a despreading system in MC-CDMA is provided, which comprises a Fourier transform unit for extracting parallel chip sequences from signal samples received over subcarriers using Discrete Fourier Transform or Fast Fourier Transform; a multiplexer for converting the parallel chip sequences into a single chip sequence; a despreading unit for performing a direct despreading for the single chip sequence using the same spreading code and chip rate as those used by the transmitting side; and a chip combining unit for sequentially combining the chip samples, corresponding to the number of chips to be combined, R, which is determined by a variable spreading factor SF, to output a received symbol sequence.

To accomplish the object of the present invention, a spreading method in MC-CDMA is also provided, which comprises a step (a) of repeating each symbol of a modulated symbol sequence for spreading, by the number of repetitions, R, which is determined by a variable spreading factor; a step (b) of performing a direct spreading for the symbols repeated at the step (a) using a spreading code of the same chip rate as the repeated symbol rate, and then dividing the spread symbol into as many parallel chips as there are subcarriers, SF_{F}, as a serial/parallel conversion; and a step (c) of transforming the chips into a sample sequence for multi-carrier transmission, using inverse Discrete Fourier Transform or Fast Fourier Transform.

To accomplish the object of the present invention, a despreading method in MC-CDMA is also provided, which comprises a step (a) of extracting parallel chip sequences received over subcarriers from a signal received from a transmitting side, using Discrete Fourier Transform or Fast Fourier Transform; a step (b) of converting the parallel chip sequences extracted at the step (a) into a single chip sequence, as a multiplexing, and performing a direct despreading for the single chip sequence using the same spreading code and chip rate as those used by the transmitting side; and a step (c) of sequentially combining the chip samples, despread at the step (b), corresponding to the number of chips to be combined, R, which is determined by a variable spreading factor SF, to output a received symbol sequence.

To accomplish the object of the present invention, there is provided a spreading/despreading method in MC-CDMA, which comprises a spreading step of repeating each symbol of a modulated symbol sequence for spreading by the number of repetitions, R, which is determined by a variable spreading factor, performing a direct spreading for the repeated symbols using a spreading code, demultiplexing the spread chips into as many parallel chip sequences as there are subcarriers, SF_{F}, and transforming the chips into a transmission symbol for multi-carrier transmission using inverse Discrete Fourier Transform or Fast Fourier Transform; and a despreading step of extracting parallel chip sequences received over subcarriers from a received signal using Discrete Fourier Transform or Fast Fourier Transform, multiplexing the parallel chip sequences into a single chip sequence, performing a direct despreading for the single chip sequence using the same spreading code and chip rate as those used by the transmitting side, and sequentially combining the despread chip samples corresponding to the number of chips to be combined, R, which is determined by the variable spreading factor SF, to output a received symbol sequence.

The spreading and despreading steps may perform two-dimensional frequency/time spreading/despreading of frequency spreading over subcarriers and direct spreading in the time domain. In the steps of Fourier transform, demultiplexing, and multiplexing, the number of the parallel chip sequences is matched with the spreading factor over subcarriers in the frequency domain.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in constitute a part of this application, illustrate embodiment(s) of the invention and together with the description serve to explain the principle of the invention. In the drawings;

FIG. 1 illustrates the configuration of a transmitter of a conventional MC-CDMA system;

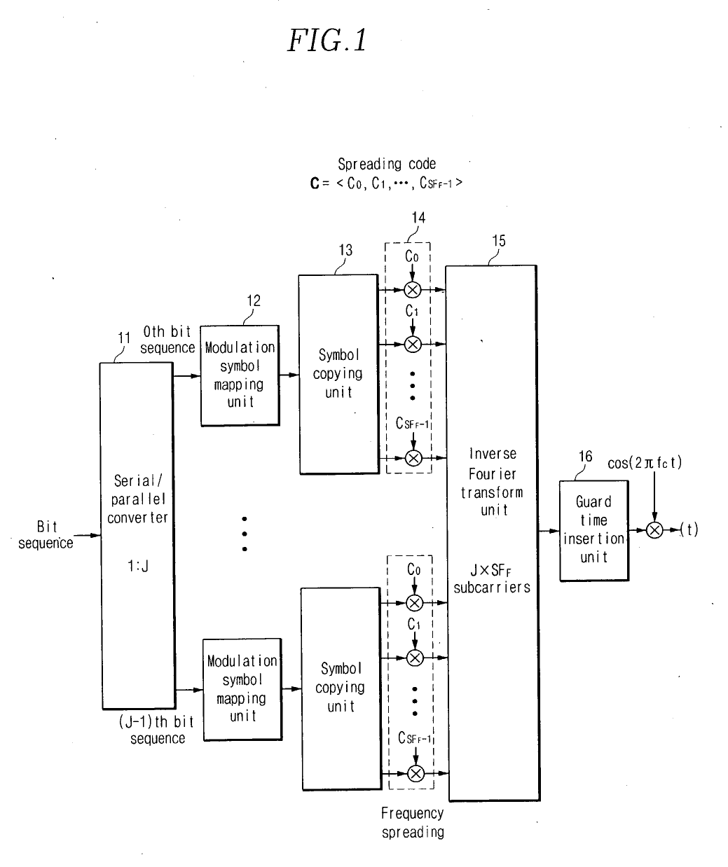

FIG. 2 illustrates the spreading procedure corresponding to one symbol sequence in FIG. 1;

FIG. 3 illustrates the configuration of a spreading system of MC-CDMA having a spreading factor reduced P times;

FIG. 4 illustrates a despreading system of a conventional MC-CDMA receiver;

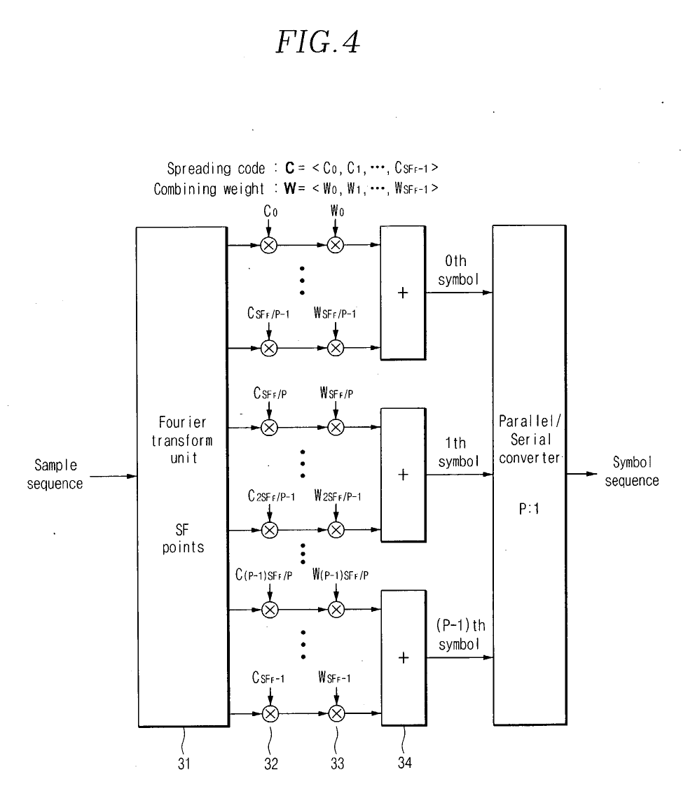

FIG. 5 illustrates the configuration of a spreading system in MC-CDMA according to a first embodiment of the present invention;

FIG. 6 illustrates the configuration of a spreading system in MC-CDMA according to a second embodiment of the present invention;

FIG. 7 illustrates the configuration of a spreading system in MC-CDMA according to a third embodiment of the present invention;

FIG. 8 illustrates the configuration of a spreading system in MC-CDMA according to a fourth embodiment of the present invention; and

FIG. 9 illustrates the configuration of a despreading system in MC-CDMA according to a preferred embodiment of the present invention.

### DETAILED DESCRIPTION OF THE INVENTION

Reference will now be made in detail to the preferred embodiments of the present invention, examples of which are illustrated in the accompanying drawings.

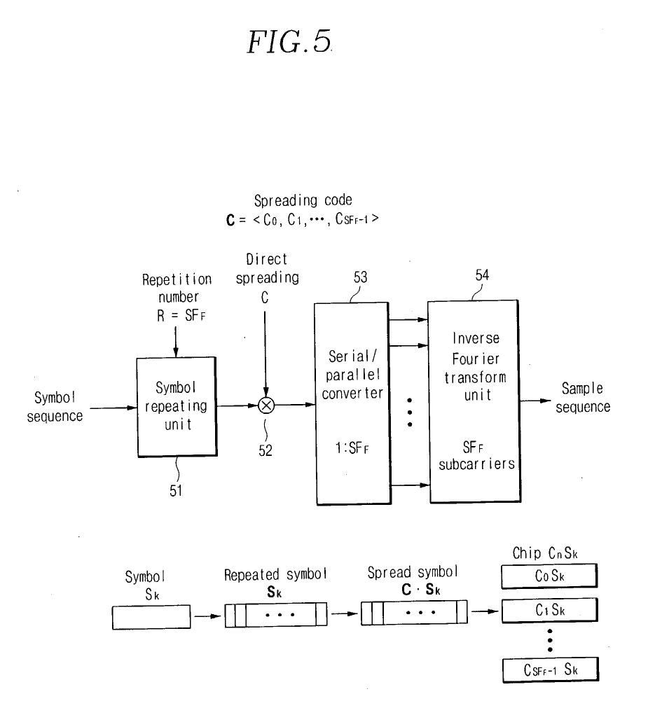

FIG. 5 illustrates the configuration of a spreading system in MC-CDMA according to a first preferred embodiment of the present invention. Referring to FIG. 5, the spreading system according to the first embodiment of the present invention includes a symbol repeating unit 51, a spreading unit 52, a demultiplexer 53, and an inverse Fourier transform unit 54.

The symbol repeating unit 51 repeats each symbol of a modulated symbol sequence for spreading, by the number of repetitions R determined by a variable spreading factor. The spreading unit 52 performs a direct spreading for the repeated symbol using a spreading code of the same chip rate as the repeated symbol rate. The demultiplexer, which is a serial/parallel converter 53, divides the spread chips generated by the spreading unit into as many parallel chip sequences as there are subcarriers, SF_{F}.

The inverse Fourier transform unit, transforms the parallel chips into a sample sequence for multicarrier transmission using inverse Discrete Fourier Transform or Fast Fourier Transform.

The operation of the spreading system according to the first embodiment of the invention, constructed as above, is described below in more detail through a spreading method in MC-CDMA according to the present invention.

The symbol repeating unit 51 repeats each symbol of the modulated symbol sequence by the number of repetitions R that is matched with the spreading factor SF_{F}. Thus, the repeated symbol becomes a symbol sequence, S_{K}=<S_{K,0}, S_{K,1}, . . . , S_{K,SF}_{_{F}}₋₁>, which is obtained in a manner such that the corresponding symbol S_{K} is repeated R=SF_{F} times.

The spreading unit 52 perform a direct spreading for the repeated symbol using a spreading code (C=<C₀, C₁, . . . , C_{SF}_{_{F}}₋₁>), as represented in the following expression (1).

C·S_{K}=<C₀S_{K}, . . . , C_{SF}_{_{F}}₋₁S_{K}> (1)

In expressions of embodiments of the present invention, A·B represents that components of two vectors A and B at the same location are multiplied by each other.

Here, the spreading code can be assigned a unique code for the discrimination of the desired signal, and a code obtained by combining a Walsh code for orthogonality and a pseudo-noise scrambling code can be used as the spreading code.

The symbol rate of the symbol repeated by the symbol repeating unit 51 is matched with the chip rate of the spreading code. The chip sequence spread by the spreading unit 52 is divided into SF_{F} parallel chip sequences by the serial/parallel converting unit 53, and the parallel chips is transformed into a transmission symbol for multicarrier transmission by the inverse Fourier-transform unit 54.

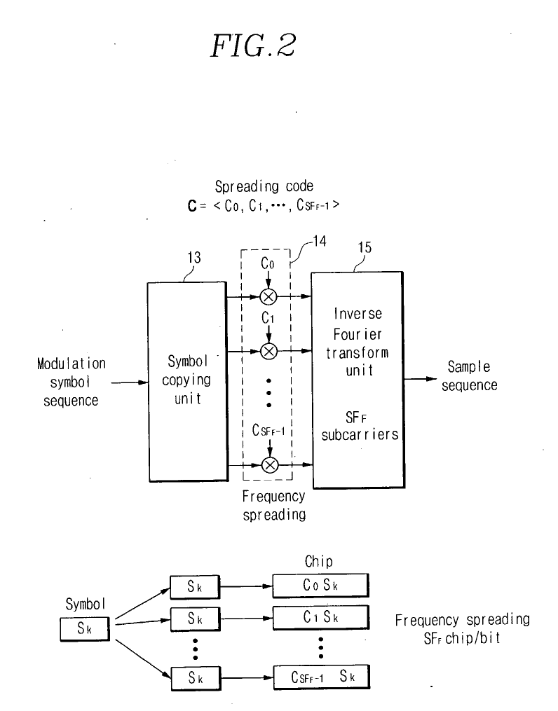

The spreading procedure according to the first embodiment of the invention, shown in FIG. 5, brings the same results as that of the spreading procedure described above with reference to FIG. 2, so as to spread and transmit a modulation symbol over subcarriers.

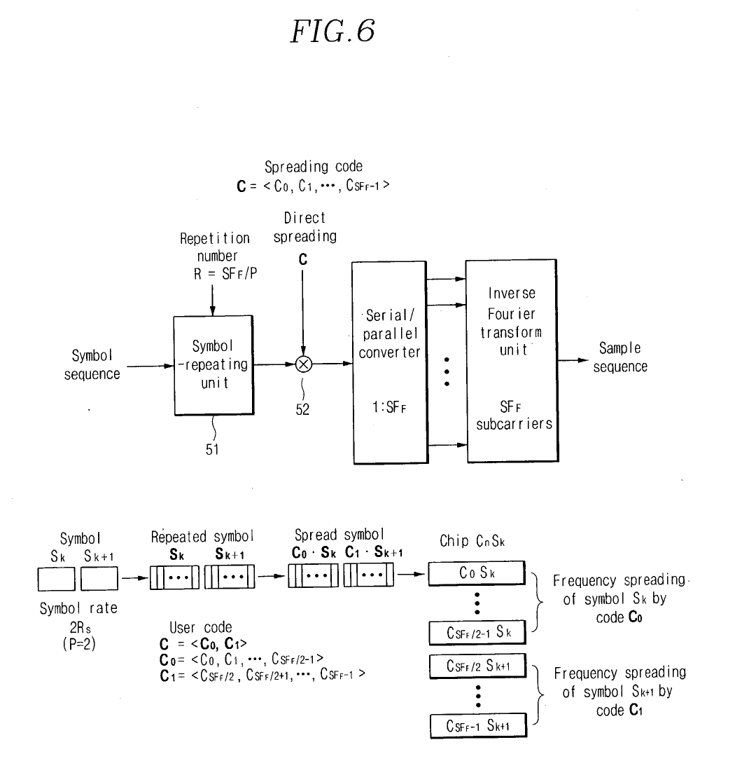

FIG. 6 illustrates the configuration of a spreading system in MC-CDMA according to a second preferred embodiment of the present invention.

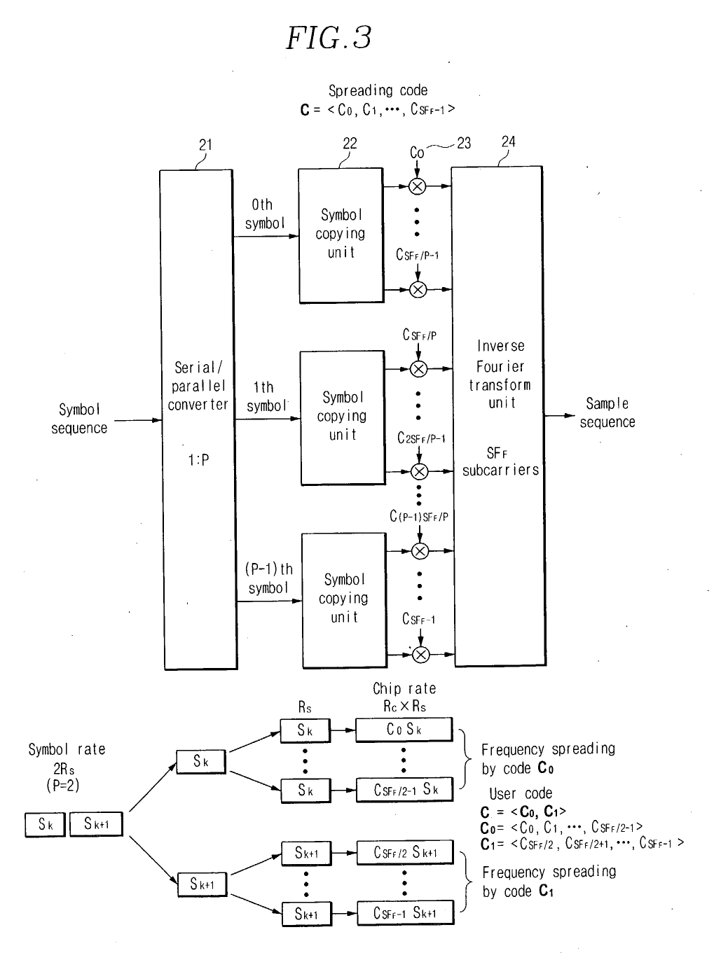

In the spreading procedure according to the first embodiment of the invention, as shown in FIG. 6, increasing the symbol (or data) transmission rate P times and spreading with a variable spreading factor SF_{F}/P can be easily performed by simply reducing the number of symbol repetition R to be SF_{F}/P. FIG. 6 shows a symbol spreading procedure in the case of P=2, which leads to the same result as that of the spreading procedure described in FIG. 3. Modulated symbols S_{K} and S_{K+1} are inputted into the symbol repeating unit 51 at the symbol rate 2Rₛ, which is twice the symbol rate of the first embodiment. Then, the symbol repeating unit 51 repeats each symbol R=SF_{F}/2 times, which is a half of the repetition number of the first embodiment, as represented by the following expression (2).

<S_{K},S_{K+1}>=<S_{K},S_{K}, . . . , S_{K},S_{K+1}, S_{K+1}, . . . , S_{K+1}> (2)

Here, the symbol rate of the symbols repeated by the symbol repeating unit 51 is matched with that of the first embodiment, and it is always matched with the system chip rate.

The repeated symbols are spread by the spreading unit 52 according to the spreading code C, as represented in the following expression (3). At this time, the symbol S_{K} is spread by a subcode C₀ including SF_{F}/2 chips in the front of the spreading code C, and the symbol S_{K+1} is spread by a subcode C₁ including SF_{F}/2 chips in the rear of the spreading code C, which are shown in the expressions (4) and (5).

<C₀·S_{K},C₁·S_{K+1}>=<C₀S_{K},C₁S_{K}, . . . , C_{SF}_{_{F}}_{/2-1}S_{K},C_{SF}_{_{F}}_{/2}S_{K+1},C_{SF}_{_{F}}_{/2+1}S_{K+1}, . . . ,C_{SF}_{_{F}}₋₁S_{K+1}> (3)

C₀=<C₀,C₁, . . . , C_{SF}_{_{F}}_{/2-1}> (4)

C₁=<C_{SF}_{_{F}}_{/2},C_{SF}_{_{F}}_{/2+1}, . . . , C_{SF}_{_{F}}₋₁> (5)

The spread chip sequence <C₀·S_{K}, C₁·S_{K+1}> is divided into SF_{F} parallel chips by the serial/parallel converter 53, and the chips are then transformed into a sequence for multi-carrier transmission by the inverse Fourier transform unit 54, as in the first embodiment of FIG. 5.

While the symbol S_{K} is spread over SF_{F} subcarriers and transmitted in the first embodiment of the invention shown in FIG. 5, the symbols S_{K} and S_{K+1} are respectively spread over SF_{F}/2 subcarriers and transmitted in the second embodiment of the invention shown in FIG. 6, which means that the symbols are transmitted at the spreading rate reduced by half.

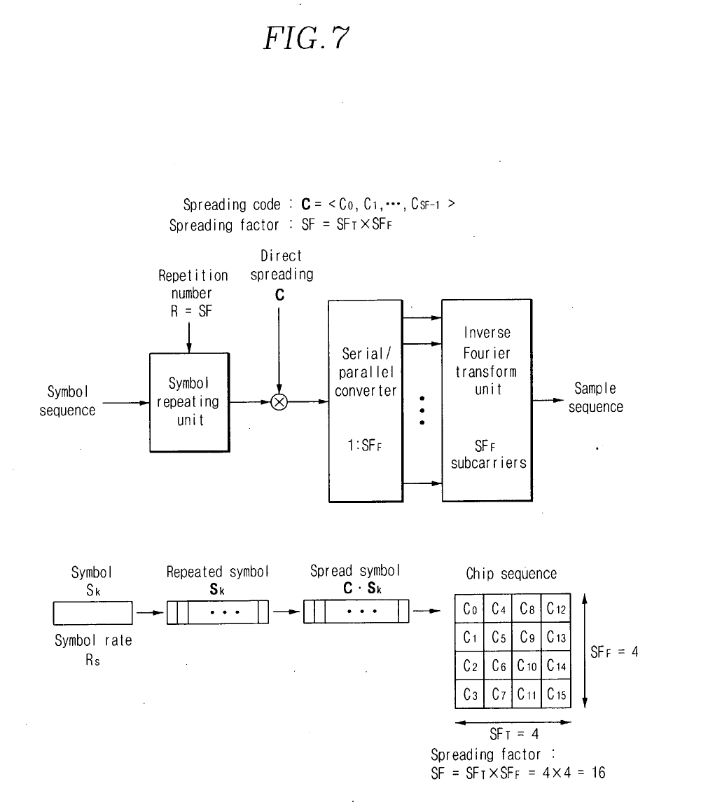

FIG. 7 illustrates the configuration of a spreading system in MC-CDMA according to a third preferred embodiment of the present invention. The MC-CDMA system shown in FIG. 7 simultaneously uses both frequency spreading over subcarriers and direct time spreading as in the DS-CDMA system to obtain processing gain and diversity gain according to an increase in the spreading factor. The third embodiment of the invention has the same configuration as that of the first embodiment shown in FIG. 5.

In the third embodiment of the present invention, the spreading factor (SF) is represented by SF=SF_{F}×SF_{T} because of two-dimensional hybrid time/frequency spreading. Here, SF_{F} represents the spreading factor in the frequency domain, and SF_{T} means the spreading factor in the time domain.

In the case where the modulated symbol is spread with this two-dimensional spreading factor, the number of parallel branches corresponding to the outputs of the serial/parallel converter and the inputs of the inverse Fourier transform unit is matched with the frequency spreading factor SF_{F}, as shown in FIG. 7. For instance, in FIG. 7 the modulated symbol S_{K} is two-dimensionally spread with the spreading factor, SF=SF_{F}×SF_{T}=4×4=16.

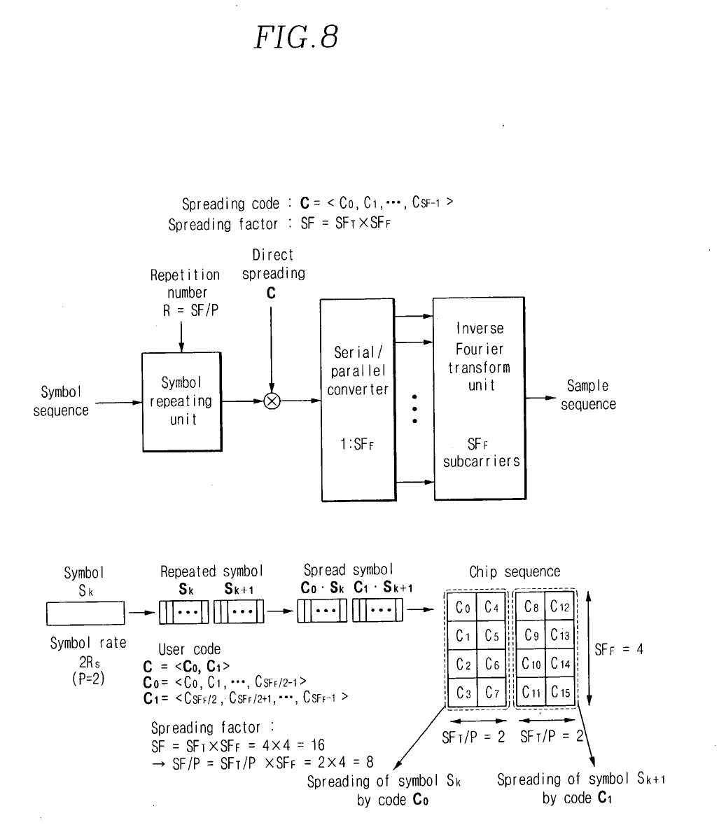

FIG. 8 illustrates the configuration of a spreading system in MC-CDMA according to a fourth preferred embodiment of the present invention. FIG. 8 shows a procedure in which spreading is carried out by simply controlling the symbol repetition number to R=SF/P without changing the configuration of the spreading system as in the aforementioned embodiments in the case where the variable spreading factor, SF/P, is applied to the two-dimensional time/frequency spreading.

In case of SF=16, to reduce the spreading factor by a half for the purpose of increasing the symbol transmission rate by two times, i.e., P=2, the symbol S_{K} is spread by the code C₀ corresponding to the first eight chips of the sixteen chips of the spreading code, and the symbol S_{K+1} is spread by the code C₁ corresponding to the remaining eight chips of the sixteen chips of the spreading code.

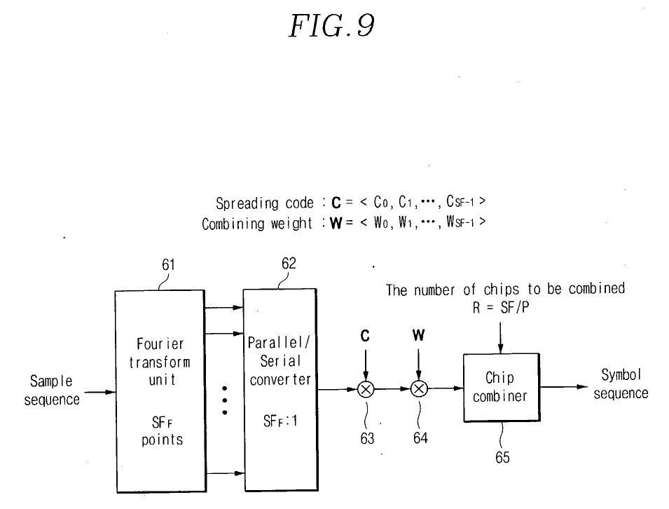

FIG. 9 illustrates the configuration of a despreading system in MC-CDMA according to a preferred embodiment of the present invention. Referring to FIG. 9, the despreading system according to the preferred embodiment of the invention includes a Fourier transform unit 61, a multiplexer 62, a despreader 63, a weighting unit 64, and a chip combiner 65.

The Fourier transform unit 61 extracts parallel chip sequences received over subcarriers from a received signal by using DFT or FFT. The multiplexer, which is a parallel/serial converter 62, converts the parallel chip sequences into a single chip sequence.

The despreader 63 directly despreads the single chip sequence outputted from the parallel/serial converter 62 using the same spreading code as used by the transmitter, at the same chip rate. The weighting unit 64 multiplies each chip by a weight which is used for chip combining.

The chip combiner 65 sequentially combines R contiguous chips, where R is determined by the variable spreading factor SF, to output a received modulated symbol sequence.

In the despreading procedure at the receiving end, the variable spreading factor can be applied to the two-dimensional hybrid spreading as well as the one-dimensional spreading in the frequency domain as in the spreading procedure described with reference to FIGS. 5 to 8.

It is apparent that the one-dimensional spreading/despreading can be seen as a part of the two-dimensional hybrid spreading/despreading. Therefore, the two-dimensional hybrid despreading is only described.

The operation of the two-dimensional hybrid despreading system in MC-CDMA according to the preferred embodiment of the invention is as follows.

At the receiving side, the Fourier transform unit 61 transforms every SF_{F} samples of a received signal into SF_{F} parallel samples over SF_{F} subcarriers, and the parallel/serial converter 62 converts a serial sample sequence including SF_{F} samples, as represented by the following expression (6).

Z₀=<Z₀,Z₁, . . . , Z_{SF}_{_{F}}₋₁> (6)

A received chip sequence including chip samples corresponding to the spreading factor SF can be obtained by carrying out the Fourier transform and parallel/serial conversion procedures sequentially SF_{T} times, and it can be represented by the following expression (7).

Z=<Z₀,Z₁, . . . , Z_{SF}_{_{T}}₋₁>

=<Z₀,Z₁, . . . , Z_{SF}_{_{F}}₋₁,Z_{SF}_{_{F}},Z_{SF}_{_{F}}₊₁, . . . , Z_{2SF}_{_{F}}₋₁, . . . , Z_{(SF}_{_{T}}₋₁_{)SF}_{_{F}},Z_{(SF}_{_{T}}_{-1)SF}_{_{F}}₊₁, . . . , Z_{SF}_{_{T}}_{SF}_{_{F}}₋₁>=<Z₀,Z₁, . . . , Z_{SF-1}> (7)

The despreader 63 performs a direct despreading for the chip sequence using the same code C as the spreading code used by the transmitter side, as represented in the following expression (8).

C·Z₀=<C₀·Z₀,C₁·Z₁, . . . , C_{SF}_{_{T}}₋₁·Z_{SF}_{_{T}}₋₁>

=<C₀Z₀,C₁Z₁, . . . , C_{SF}_{_{F}}₋₁Z_{SF}_{_{F}}₋₁,C_{SF}_{_{F}},C_{2SF}_{_{F}}₋₁Z_{SF}_{_{F}}₊₁, . . . , C_{2SF}_{_{F}}₋₁Z_{2SF}_{_{F}}₋₁, . . . , C_{(SF}_{_{T}}_{-1)SF}_{_{F}}Z_{(SF}_{_{T}}_{-1)SF}_{_{F}},C_{(SF}_{_{T}}_{-1)SF}_{_{F}}₊₁Z_{(SF}_{_{T}}_{-1)SF}_{_{F}}₊₁, . . . , C_{SF}_{_{T}}_{SF}_{_{F}}₋₁Z_{SF}_{_{T}}_{SF}_{_{F}}₋₁>=<C₀Z₀,C₁Z₁, . . . , C_{SF-1}Z_{SF-1}> (8)

The weighting unit 64 multiplies each of the chips of the expression (8) by a weight w, as represented in the following expression (9). Here, the weight values used for chip combining can be determined by a method of ORC, EGC, MRC, MMSEC, or the like.

X=W·C·Z=<W₀C₀·Z₀,W₁·C₁·Z₁, . . . , W_{SF}_{_{T}}₋₁·C_{SF}_{_{T}}₋₁·Z_{SF}_{_{T}}₋₁>=<W₀C₀Z₀,W₁C₁Z₁, . . . ,W_{SR-1}C_{SF-1}Z_{SF-1}>=<X₀,X₁, . . . ,X_{SF-1}> (9)

The chip combiner 65 combines R=SF/P contiguous chip samples as, to obtain a received modulated symbol, Yₘ, as represented by the following expression (10).

$${Y}_{m} = {\sum }_{n = 0}^{R - 1} {X}_{mR + n} , m = 0 , 1 , … , P - 1 \qquad ( 10 )$$

This chip-combining procedure is sequentially repeated P times so as to obtain P received symbols <Y₀, Y₁, . . . , Y_{P-1}>, which is corresponding to the despreding by the whole spreading code C.

Though spreading and despreading procedures for one symbol sequence were explained in the aforementioned embodiments, the embodiments of the invention can be applied to spreading and despreading for each symbol sequence in a MC-CDMA system that transmits more than one symbol sequences in parallel.

Furthermore, the embodiments of the present invention can be employed irrespective of a modulation type, code type, and Fourier transform procedure.

In the MC-CDMA system, it can be required to simultaneously use both frequency spreading over subcarriers and direct spreading in time domain as in DS-CDMA systems. This two-dimensional frequency/time spreading provides a spreading factor larger than the number of subcarriers used in the system so that it is employed when a large processing gain is needed.

In the case where a signal transmitted by the two-dimensional spreading method is received through a multipath fading channel, it is possible to obtain frequency diversity according to spreading over subcarriers, and multipath time diversity by the direct spreading and Rake receiver in addition to a high processing gain.

The forgoing embodiments are merely exemplary and are not to be construed as limiting the present invention. The present invention can be readily applied to other types of apparatuses. The description of the present invention is intended to be illustrative, and not to limit the scope of the claims. Many alternatives, modifications, and variations will be apparent to those skilled in the art.

The spreading/despreading system and method in MC-CDMA according to the present invention provides simple spreading and despreading procedures so that frequency spreading/despreading over subcarriers and time direct spreading/despreading can be simultaneously carried out. Furthermore, the present invention may easily realize a variable spreading factor for supporting a variable transmission rate. Therefore, the spreading/despreading system and method in MC-CDMA according to the present invention can obtain frequency diversity and multipath time diversity in addition to a high processing gain through two-dimensional time/frequency spreading/despreading, and can easily provide a variable spreading factor through the same procedure as that of the prior art.

What is claimed is:

1. A spreading system in multi-carrier code division multiple access (MC-CDMA), comprising:
a symbol repeating unit for repeating each symbol of a modulated symbol sequence, inputted for spreading in a signal-forming procedure of MC-CDMA, by the number of repetition, R, which is determined by a variable spreading factor;
a spreading unit for a direct spreading for the symbols repeated by the symbol repeating unit using a spreading code of the same chip rate as the symbol rate, to obtain a spread chip sequence;
a demultiplexer for dividing the chip sequence spread by the spreader into as many parallel chip sequences as there are subcarriers, SF_{F}, through a serial/parallel conversion; and
an inverse Fourier transform unit for transforming the chips into a transmission symbol, which includes SF_{F} samples for the multi-carrier transmission over SF_{F} subcarriers.

2. The spreading system in MC-CDMA, as claimed in claim 1, wherein the symbol repeating unit reduces the number of repeated symbols, R=SF_{F}/P, P times in order to spread the modulated symbols with a reduced spreading factor of SF_{F}/P for a variable transmission rate.

3. The spreading system in MC-CDMA, as claimed in claim 1, wherein, in the case of two-dimensional hybrid spreading in time and frequency domains, the spreading factor is represented by the product of the spreading factor SF_{T} in the time domain and the spreading factor SF_{F} in the frequency domain.

4. The spreading system in MC-CDMA, as claimed in claim 1, wherein the number of parallel chip sequences divided by the demultiplexer is matched with the spreading factor SF_{F} in the frequency domain, for a frequency spreading over subcarriers.

5. The spreading system in MC-CDMA, as claimed in claim 1, wherein the symbol repeating unit reduces the number of repeated symbols, R=SF/P=SF_{T}/P×SF_{F}, P times in order to spread the modulated symbols with a reduced spreading factor of SF/P for a variable transmission rate.

6. A despreading system in MC-CDMA, comprising:
a Fourier transform unit for extracting parallel chip sequences received over subcarriers from a received signal, using a Discrete Fourier Transform (DFT) or Fast Fourier Transform (FFT);
a multiplexer for parallel-to-serial-converting the parallel chip sequences extracted by the Fourier transform unit into a single chip sequence;
a despreader for performing a direct despreading for a single chip sequence outputted from the multiplexer using the same spreading code and chip rate as those used by the transmitting side; and
a chip combiner for sequentially combining chip samples, despread by the despreader, corresponding to the number of chips to be combined, R, which is determined by a variable spreading factor SF, to obtain a received modulated symbol sequence.

7. The despreading system in MC-CDMA, as claimed in claim 6, wherein the despreader multiplies each chip by a weight used for a chip combining.

8. The despreading system in MC-CDMA, as claimed in claim 6, wherein, with the chip combiner, the number of chips to be combined (R=SF/P) is reduced P times when the variable spreading factor is decreased P times.

9. The despreading system in MC-CDMA, as claimed in claim 6, wherein, in the case of two-dimensional hybrid despreading in time/frequency domains, the spreading factor is represented by the product of the spreading factor SF_{T} in the time domain and the spreading factor SF_{F} in the frequency domain.

10. The despreading system in MC-CDMA, as claimed in claim 6, wherein the number of the parallel chip sequences of the Fourier transform unit and the multiplexer is matched with the spreading factor SF_{F} in the frequency domain over subcarriers.

11. The despreading system in MC-CDMA, as claimed in claim 6, wherein the Fourier transform unit and the multiplexer generate a received chip sequence including SF=SF_{F}×SF_{T} chip samples by sequentially carrying out Fourier transform and parallel/serial conversion procedures SF_{T} times.

12. A spreading method in MC-CDMA, comprising:
(a) repeating each symbol of a modulated symbol sequence, inputted for spreading in a signal-forming procedure of MC-CDMA, by the number of repetition, R, which is determined by a variable spreading factor;
(b) producing spread chip sequences from the repeated symbols in (a) by a direct spreading using a spreading code of the same chip rate as the repeated symbol rate, and then dividing the spread chips into as many parallel chips as there are subcarriers, SF_{F}, through a serial/parallel conversion; and
(c) transforming parallel SF_{F} chips obtained in (b) into a transmission symbol for the multicarrier transmission over SF_{F} subcarriers by using inverse DFT or FFT.

13. The spreading method in MC-CDMA, as claimed in claim 12, wherein (a) reduces the number of repeated symbols, R=SF_{F}/P, P times in order to spread the modulated symbols with a reduced spreading factor of SF_{F}/P for a variable transmission rate.

14. The spreading method in MC-CDMA, as claimed in claim 12, wherein, in the case of two-dimensional hybrid spreading in time/frequency domains, the spreading factor is represented by the product of the spreading factor SF_{T} in the time domain and the spreading factor SF_{F} in the frequency domain in (a).

15. The spreading method in MC-CDMA, as claimed in claim 12, wherein the number of the parallel chip sequences in (c) is matched with the spreading factor SF_{F} in the frequency domain, over SF_{F} subcarriers.

16. The spreading system in MC-CDMA, as claimed in claim 12, wherein (a) reduces the number of repeated symbols, R=SF/P=SF_{T}/P×SF_{F}, P times in order to spread the modulated symbols with a reduced spreading factor of SF/P for a variable transmission rate.

17. A despreading method in MC-CDMA, comprising:
(a) extracting parallel chip sequences received over subcarriers from a received signal, using Discrete Fourier transform or Fast Fourier Transform;
(b) converting the parallel chip sequences extracted in (a) into a single chip sequence using a parallel-to-serial conversion, and performing a direct despreading for the single chip sequence using the same spreading code and chip rate as those used by the transmitting side; and
(c) sequentially combining chip samples, obtained in (b), corresponding to the number of chips to be combined, R, which is determined by a variable spreading factor SF, to generate a received modulated symbol.

18. The despreading method in MC-CDMA, as claimed in claim 17, wherein (b) multiplies each chip by a weight used for the chip combining.

19. The despreading method in MC-CDMA, as claimed in claim 17, wherein, in (c), the number of chips to be combined is reduced P times when the variable spreading factor is decreased P times.

20. The despreading system in MC-CDMA, as claimed in claim 17, wherein, in the case of two-dimensional hybrid despreading in time/frequency domains, the spreading factor is represented by the product of the spreading factor SF_{T} in the time domain and the spreading factor SF_{F} in the frequency domain.

21. The despreading system in MC-CDMA, as claimed in claim 17, wherein the number of parallel chip sequences in (b) is matched with the spreading factor SF_{F} in the frequency domains over SF_{F} subcarriers.

22. The despreading system in MC-CDMA, as claimed in claim 17, wherein, (a) and
(b) generate a received symbol including chip samples corresponding to the spreading factor SF=SF_{F}×SF_{T} by carrying out Fourier transform and parallel/serial conversion procedures SF_{T} times.

23. A spreading/despreading method in MC-CDMA, comprising:
a spreading step of repeating each symbol of a modulated symbol sequence, for spreading in a signal forming procedure of MC-CDMA, by the number of symbol repetition, R, which is determined by a variable spreading factor, performing a direct spreading for the repeated symbols using a spreading code, demultiplexing the spread symbol into as many parallel chip sequences as there are subcarriers, SF_{F}, and transforming the parallel chips into a transmission symbol over SF_{F} subcarriers by using inverse DFT or FFT; and
a despreading step of extracting parallel chip sequences received over subcarriers from a received signal using DFT or FFT, multiplexing the parallel chip sequences into a single chip sequence, performing a direct despreading for the single chip sequence using the same spreading code and code rate as those used by the transmitting side, and sequentially combining the despread chip samples corresponding to the number of chips to be combined, R, which is determined by the variable spreading factor, SF, to output a received modulated symbol.

24. The spreading/despreading method in MC-CDMA, as claimed in claim 23, wherein the spreading and despreading steps is a two-dimensional frequency/time spreading/despreading of frequency spreading over subcarriers and direct spreading in the time domain.

25. The spreading/despreading method in MC-CDMA, as claimed in claim 23, wherein, in the steps of Fourier transform, demultiplexing and multiplexing, the number of parallel chip sequences is matched with the spreading factor in the frequency domain over subcarriers.
